(19) United States
(12) Patent Application Publication
(10) Pub. No.: US 2009/0195076 A1
(43) Pub. Date: Aug. 6, 2009

(54) System Comprising at Least Two Guideway-Related Guideway Components of a Track Guideway and a Transformer Station

(75) Inventors: Wilfried Glaubitz, Neunkirchen (DE); Jürgen Gress, Lauf (DE); Wolfgang Spaeth, Erlangen (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munchen (DE)

(21) Appl. No.: 12/302,921

(22) PCT Filed: May 31, 2006
(86) PCT No.: PCT/DE2006/000972

§ 371 Date: Jan. 6, 2009

(51) Int. Cl. H02J 3/00

(52) U.S. Cl. 307/69

(57) ABSTRACT

A system has at least two guideway-related guideway components of a track guideway and a transformer station, which is electrically connected to the at least two guideway components and supplies the same with an output voltage for the purpose of power supply. The transformer station generates, on the output side, a higher output voltage than the guideway component connected thereto requires as the operating voltage for its operation. The guideway components are equipped with respective voltage reducing devices which reduce the supply voltage, supplied by the transformer station, to the operating voltage which the individual guideway component requires.

The invention relates to a system having the features as claimed in the preamble of claim 1.

Track guideways such as railroad tracks or magnetic levitation rail tracks are known to be equipped with guideway-related guideway components. Said guideway components are usually supplied with electrical energy which is provided by a transformer station which is connected to the guideway components. The guideway components can be, for example, switches, communications devices, signal devices or the like.

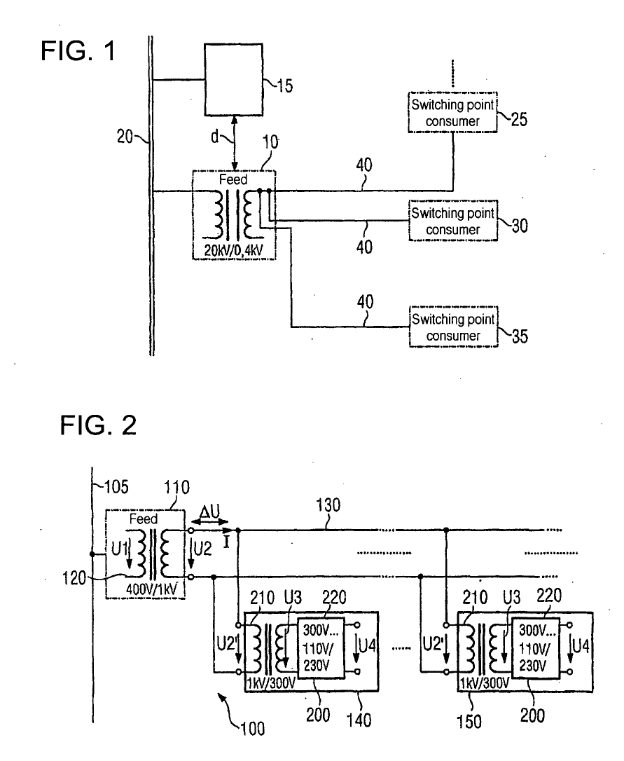

For example, the Transrapid line built in Shanghai has a large number of transformer stations which are each connected to a predefined number of guideway components in the form of switching points. The switching points carry out stator section switching in synchronism with the vehicle. FIG. 1 shows this arrangement schematically. FIG. 1 shows two transformer stations 10 and 15 which are connected on the input side to a 20 kV feed line 20. The 20 kV feed line 20 is, for example, a central voltage cable ring which makes available a power supply from one substation to another. The distance d between the transformer stations 10 and 15 is on average approximately 4 km. On the output side, the two transformer stations are respectively connected in a star shape to a predefined number of switching points; the switching points of the transformer station 10 are characterized in FIG. 1 by the reference symbols 25, 30 and 35.

The connecting lines 40 between the transformer station and the switching points are, in the case of the Transrapid line, three-phase current cables to which a voltage of 400 V is applied.

The individual connecting lines 40 are configured individually according to the maximum anticipated voltage drop on the respective line and said configuration has to be tailored to the maximum possible load of each individual switching point. Because of the requirements which are made of the switching reliability of the contactors and of the monitoring electronic system of the switching point the permissible supply voltage tolerance should be at maximum between −7% and +10% of the nominal voltage. In order to comply with this specification, the nominal cross sections of the cables of the connecting lines 40 have to be given relatively large dimensions in order to allow for the respective voltage drop across the line. Given a distance of 2 km between the switching point 25 and the transformer station 10, a conductor cross section of 25 mm², for example, may be necessary when a copper cable is used.

The invention is based on the object of developing a system of the type specified at the beginning to the effect that project planning can be carried out more easily than in the past for such a system and said system can be manufactured more cost-effectively than in the past.

This object is achieved according to the invention by means of a system having the features as claimed in claim 1. Advantageous refinements of the invention are specified in subclaims.

Accordingly, the invention provides that the transformer station is configured in such a way that it generates, on the output side, a higher output voltage than the connected guideway components require as an operating voltage for their operation, and in that the guideway components are each equipped with a voltage

reducing device which reduces the supply voltage supplied by the transformer station to the operating voltage which is respectively required by the individual guideway components.

A significant advantage of the system according to the invention is to be seen in the fact that in said system the connecting lines between the transformer station and the guideway components which are connected thereto do not have to be dimensioned individually with respect to their electrical loading, and this is because the application of a higher voltage to the connecting lines than the guideway components actually require ensures that the necessary energy can be transformed with a comparatively low current. Specifically, the necessary current is lower the higher the supply voltage selected. The lower in turn the current is, the smaller the voltage drop across the connecting line and therefore the smaller the fluctuations in the supply voltage at the input of the respective guideway component in the case of load fluctuations. Owing to the inventive concept of transmitting a higher supply voltage than is necessary on the part of the guideway components and of individually adapting the voltages within the guideway components, the expenditure on project planning with respect to the selection and dimensioning of the connecting lines is significantly lower than in the past. The explained lower expenditure on project planning then plays a very important economic role in particular if structural changes have to be made during the planning phase or even after the system has been finished and as a result the lengths of the connecting lines subsequently change, and this is because with the invention changes to the line length for the selection of the line cross section play no role at all, or at least an insignificant one, because of the only

low supply currents.

A further significant advantage of the system according to the invention is to be seen in the fact that said system involves fewer costs than the system previously known from the Transrapid, and this is because owing to the relatively low supply currents on the connecting lines it is possible to use lines with a relatively small cross section so that the line costs drop drastically. Although some of this cost advantage is obviated by the voltage reducing devices which are necessary on the part of the guideway components, the system according to the invention still provides a significant cost advantage overall.

In order to ensure that the operating voltage for the guideway components remains approximately constant, it is considered advantageous if the voltage reducing devices for the guideway components each have a compensation device which compensates load-induced fluctuations in the supply voltage present at the respective guideway component in such a way that a constant, at least approximately constant, operating voltage is formed for the respective guideway component.

The compensation devices are preferably configured in such a way that the load-induced fluctuation in the supply voltage which is present at the respective guideway component is in the range between −50% and +20% of the respective nominal value.

In order to achieve the lowest possible flow of current in the connecting lines, it is considered advantageous if the output voltage is at least twice as high as the maximum necessary operating voltage of the guideway components.

The system is preferably used to supply electrical auxiliary power to a section of magnetic levitation rail track. In this case, it is considered advantageous if the at least two guideway components each form a switching point which is connected to a trackside stator section of the magnetic levitation rail track and ensures switching over of the stator section for the magnetic levitation rail track which is synchronized with the vehicle.

According to a first advantageous variant of the system, the transformer station and the at least two guideway components are connected by means of a power bus cable to which each guideway component is connected without an electrical interruption in the power bus cable. A significant advantage of this variant is that there is a saving in terms of lines and therefore investment costs and laying costs because, instead of a star-shaped connection between each of the switching points and the transformer station, essentially only a single cable is necessary, specifically a cable which extends from the transformer station to the most remote switching point and in doing so makes electrical contact with the switching points between them as it passes them. The power bus cable is, for example, single-phase in order to reduce line costs.

According to a second advantageous variant of the system, the guideway components are arranged electrically in a chain in such a way that each chain element which is formed by a guideway component is connected by an individual cable section to the chain element which is respectively arranged in front of it and the chain element which is respectively arranged after it, wherein the cable section for the chain element arranged after and the cable section for the chain element arranged in front are electrically connected to one another by means of a looped-through connection, and wherein at least one of the chain elements is electrically connected to the

transformer station by means of a connecting cable. The cable sections and the connecting cable are preferably single-phase in order to reduce line costs.

Four-conductor alternating current lines are particularly preferably used for the power bus cable or for the cable sections and the connecting cable. In said four-conductor alternating current lines in each case two conductors which are diagonally opposite one another are preferably connected in parallel in order to minimize the line reactance (resistance and inductance) and to optimize the transmission properties.

The voltage reducing devices can be formed particularly cost-effectively, and therefore advantageously, with single-phase transformers, in particular annular core transformers.

The guideway components which are supplied by the transformer station can be, for example, switch controllers, telecommunications devices or radio devices.

The invention also relates to a method for supplying at least two guideway-related guideway components of a track guideway with electrical energy, in which the guideway components are supplied electrically with a supply voltage from the same transformer station.

In order to be able to carry out such a method easily and cost-effectively, the invention proposes that the transformer station is used to generate, on the output side, a higher output voltage than the guideway components require as an operating voltage for their operation, and in that, in the guideway components, the supply voltage which is respectively supplied by the transformer station is reduced, in particular adjusted downward, with a voltage reducing device to the operating voltage which is respectively

required by the individual guideway components.

With respect to the advantages of the method according to the invention and with respect to the advantages of advantageous refinements of the method according to the invention, reference is made to the above statements relating to the system according to the invention.

The invention will be explained in more detail below by means of exemplary embodiments, in which, by way of example,

FIG. 2 shows an exemplary embodiment of a system according to the invention having a power bus cable, by means of which system the method according to the invention is also explained by way of example,

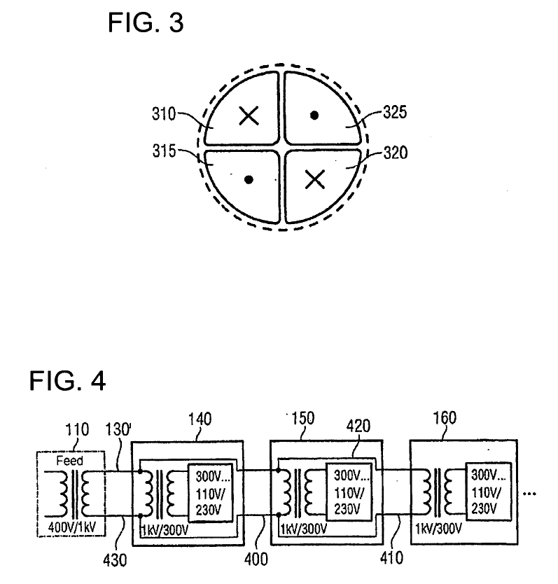

FIG. 3 shows an exemplary embodiment of a power bus cable for the system according to FIG. 2, and

FIG. 4 shows a second exemplary embodiment of a system according to the invention having a looped-through cable.

In FIGS. 1 to 4, the same reference symbols are used for identical or comparable components for reasons of clarity.

FIG. 2 shows an electrical system 100 which can be used for a section of a magnetic levitation rail track. The system 100 comprises a power network 105 which is operated, for example, with a voltage U1=400 V. A transformer station 110 is connected to the power network 105.

The transformer station 110 has a transformer 120 which transforms the voltage U1 which is present on the input side into a higher output voltage U2 of, for example, U2=1 kV. On the output side, the transformer 120, and therefore the transformer station 110, is connected to a power bus cable 130 to which a plurality of guideway components are connected, two of which guideway components are characterized by the reference symbols 140 and 150 in FIG. 2.

The object of the power bus cable 130 comprises supplying the guideway components of the section of magnetic levitation rail track with auxiliary power from one substation to another.

The guideway components 140 and 150 may be, for example, switch controllers, telecommunications devices, radio devices or the like. In the text which follows it is assumed, by way of example, that the guideway components 140 and 150 are each switching points which are connected to a trackside stator section of the section of magnetic levitation rail track and that they ensure switching over of the stator section for the magnetic levitation rail track in synchronism with the vehicle.

The two switching points 140 and 150 each have, on the input side, a voltage reducing device 200 which is equipped, for example, with a transformer 210, in particular an annular core transformer. The transformer 210 transforms the supply voltage U2′ which is present on the input side and which corresponds, discounting any voltage drop ΔU across the power bus cable 130, to the output voltage U2 of the transformer station 110, into a reduced supply voltage U3 of, for example, 300 V. The transformer 210 is accordingly a 1 kV/300 V transformer, for example.

The transformer 210 is connected on the output side to a compensation device 220, which compensation device 220 is part of the voltage reducing device 200. The compensation device 220 can be, for example, a voltage constant control circuit (for example IPS (interruption-free power supply) with or without a battery, power system transformer with a power pack, power inverter, controlled transformer) which has the widest possible permissible input voltage range of, for example, 110 V to 300 V. On the output side, the compensation device 220 generates a relatively constant operating voltage U4 of, for example, 230 V. The operating voltage U4 is further processed by other components of the guideway components 140 and 150 which are not shown in more detail in FIG. 2 for the sake of clarity.

The power bus cable 130 can be formed, for example, by a four-conductor cable such as is shown in more detail in FIG. 3. The cable 130 has four sector conductors 310, 315, 320 and 325. These are preferably wired in such a way that the sector conductors which each lie diametrically opposite one another are connected in parallel. In the example in FIG. 3, the current in the conductors 310 and 320 therefore flows, considered diagrammatically, into the plane of the drawing, while the current of the conductors 315 and 325 flows out of the plane of the drawing, considered diagrammatically. This wiring of the power bus cable 130 reduces the inductance of the line and increases the capacitance of the line with the result that the voltage drop across the line is decreased and the reactive current requirement of the transformer station 110 is at least partially compensated.

The system according to FIG. 2 can be operated as follows:

A voltage U1 of, for example, 400 V is fed into the transformer station 110 with the power network 105. The transformer

station 110 transforms the voltage U1 which is present on the input side into a higher output alternating voltage U2 of, for example, 1 kV.

The output voltage U2 passes, as supply voltage U2′, to the transformer 210 which converts the supply voltage U2′ into a reduced supply voltage U3 of, for example, 300 V. The compensation device 220 generates, with the reduced supply voltage U3, a relatively constant operating alternating voltage U4 of, for example, 230 V.

In the case of a very high current I in the power bus cable 130, a relatively large voltage drop ΔU can occur on the power bus cable 130 so that the voltage supply U2′ is, under certain circumstances, significantly reduced. Specifically the following applies:

U2=U2′+ΔU

In the system according to FIG. 2, such a voltage drop ΔU is thankfully not critical at all since enough “voltage margin” is present. Even if the voltage drop ΔU becomes half as large as the output voltage Δ2, the system according to FIG. 2 can continue to operate, this is because the voltage supply U2′ is, in this case, still 500 V, which is sufficient to operate the compensation device 220. The supply voltage U2′=500 V is specifically converted in the transformer 210 to form a reduced supply voltage U3 of 150 V which is still within the already mentioned, permissible input voltage range of the compensation device 220 between 110 V and 300 V.

An advantage of the power bus cable 130 is, moreover, that as a result of

local and chronological switching forward of the respectively active switching point which occurs during operation of the magnetic levitation rail track, only very few switching points (consumers) which are connected to the transformer station 110 have to be supplied with the full power, while at the other switching points (consumers) a reduced power for the basic load is sufficient. The power bus cable 130 therefore only has to be optimized with respect to this load.

In terms of the dimensioning of the guideway components, it is mentioned in conclusion that they should be able to draw an input current which is as sinusoidal as possible (crest factor approximately 1.41) so that the voltage drop on the power bus cable 130 remains as small as possible. Alternatively or additionally, the guideway components can be equipped with an active PFC (power factor correction) device in order to optimize the crest factor. The reactive current requirement of the guideway components should also be as small as possible.

A further exemplary embodiment of a system is shown in FIG. 4. In contrast to the exemplary embodiment in FIG. 2, in this system there is no power bus cable 130 but rather a looped-through connecting line 130′. Specifically, the guideway components 140, 150 and 160 are arranged electrically in a chain. The central chain element 150 is connected here to the chain element 140 which is arranged in front by means of an individual cable section 400, and to the chain element 160 which is arranged after by means of a further individual cable section 410. The two cable sections 400 and 410 are electrically connected to one another by means of a looped-through connection 420 within or outside the chain element 150. At least one of the chain elements, here the chain element 140, is electrically connected to the transformer station 110 by means of a connecting cable 430.

Of course, further chain elements can be connected in a corresponding way to the chain element 160, as is indicated schematically by dots to the right of the chain element 160 in FIG. 4.

It is also to be noted that the guideway components 140 and 150 according to FIG. 2, and the guideway components 140, 150 and 160 according to FIG. 4 can be configured in different ways and, for example, generate and process different voltages U3 and U4.

List of reference symbols

| | |
|---|---|
| 10, 20 | Transformer stations |
| 20 | Feed line |
| 25, 30, 35 | Switching points |
| 40 | Connecting lines |
| 100 | System |
| 105 | Power network |
| 110 | Transformer station |
| 120 | Transformer |
| 130 | Power bus cable |
| 140, 150, 160 | Guideway components |
| 200 | Voltage reducing device |
| 210 | Transformer |
| 220 | Compensation device |
| 310, 315 | Sector conductor |
| 320, 325 | Sector conductor |
| 400, 410 | Cable section |
| 420 | Looped-through connection |
| 430 | Connecting cable |
| U1, U2, U2′, U3 | Voltages |
| I | Current |
| d | Distance |

1-10. (canceled)

11. A guideway system, comprising:
at least two guideway-related guideway components of a track guideway, said guideway components each having a defined operating voltage required for an operation thereof;
a transformer station electrically connected to said guideway components for supplying said guideway components with electrical power, said transformer station outputting an output voltage higher than the defined operating voltage required by said guideway components for the operation thereof; and
each of said guideway components being equipped with a voltage reducing device configured to reduce a supply voltage supplied from said transformer station to the defined operating voltage respectively required by the individual said guideway component.

12. The system according to claim 11, wherein said voltage reducing device of each said guideway component includes a compensation device configured to compensate for load-induced fluctuations in the supply voltage present at the respective said guideway component and to provide a substantially constant operating voltage for the respective said guideway component.

13. The system according to claim 12, wherein said compensation device is configured to compensate for load-induced fluctuations in the supply voltage present at the respective said guideway component in a range between −50% and +20% of a respective nominal value.

14. The system according to claim 11, configured to supply electrical auxiliary power to a section of a magnetic levitation rail track.

15. The system according to claim 14, wherein each of said guideway components forms a switching point connected to a trackside stator section of the magnetic levitation rail track and ensures switching over of the stator section for the section of magnetic levitation rail track in synchronism with a vehicle traveling on the rail track.

16. The system according to claim 11, which comprises a power bus cable connecting said transformer station with said at least two guideway components, and wherein each said guideway component is connected to said power bus cable without an electrical interruption in said power bus cable.

17. The system according to claim 16, wherein said power bus cable is a single-phase.

18. The system according to claim 11, wherein said guideway components are electrically connected in a chain, with each chain element formed by a respective said guideway component connected by an individual cable section to the chain element respectively disposed in front and the chain element respectively disposed after the respective said guideway component;
wherein the cable section for the chain element disposed after and the cable section for the chain element disposed in front are electrically connected to one another by way of a looped-through connection; and
which further comprises a connecting cable electrically connecting at least one of the chain elements to said transformer station.

19. The system according to claim 11, wherein said voltage reducing device of at least one of said guideway components includes a transformer.

20. The system according to claim 19, wherein said transformer is an annular core transformer.

21. The system according to claim 11, wherein said guideway component is selected from the group consisting of a track switch controller, a telecommunications device, and a radio device.

22. A method for supplying at least two guideway-related guideway components of a track guideway with electrical energy, which comprises:
electrically supplying the at least two guideway components with a supply voltage from a common transformer station;
generating, at an output side of the transformer station, a higher output voltage than the guideway components require as an operating voltage for an operation thereof; and
reducing a supply voltage received from the transformer station at the respective guideway component, with a voltage reducing device to the operating voltage respectively required by the individual guideway component for the operation thereof.
